(19) United States
(12) Patent Application Publication
(10) Pub. No.: US 2024/0384890 A1
(43) Pub. Date: Nov. 21, 2024

(54) HEATING MEANS, PUMP WITH SUCH A HEATING MEANS AND WATER-CONDUCTING DOMESTIC APPLIANCE

(71) Applicant: E.G.O. Elektro-Gerätebau GmbH, Oberderdingen (DE)

(72) Inventors: Manuel Schmieder, Oberderdingen (DE); Matthias Mandl, Eppingen-Mühlbach (DE); Holger Köbrich, Kraichtal-Gochsheim (DE); Roland Mühlnikel, Bretten (DE); Michael Tafferner, Malsch (DE); Volker Block, Bretten (DE)

(21) Appl. No.: 18/660,407

(22) Filed: May 10, 2024

(30) Foreign Application Priority Data
May 16, 2023 (DE) 10 2023 112 929.5

(51) Int. Cl. F24H 1/10; F04D 1/00; F04D 29/42; F04D 29/58; F24H 15/132; F24H 15/212

(52) U.S. Cl. CPC F24H 1/102; F04D 1/00; F04D 29/4293; F04D 29/586; F24H 15/132; F24H 15/212; H05B 2203/007; H05B 2203/013; H05B 2203/016

(57) ABSTRACT

A heating means installed in a pump for heating water during pumping has a tubular cylindrical holder that defines a heating chamber for the water. On the outside of the holder, a plurality of heating conductor tracks are connected together in series. The heating means is configured for operation of the pump in the horizontal state, such that its longitudinal axis extends horizontally. In this horizontal state, the heating means has a residual water level as a horizontal plane that lies roughly in the lower third. Apart from two heating conductor tracks, the heating conductor tracks extend below this residual water level, while said two heating conductor tracks extend above the residual water level. In the absence of cooling water on the inner surface of the heating chamber, they can overheat more quickly and be locally destroyed as an emergency safety device before the entire heating means is at risk of overheating.

### CROSS-REFERENCE TO RELATED APPLICATIONS

This application claims priority to German Application No. 10 2023 112 929.5, filed May 16, 2023, the contents of which are hereby incorporated herein in its entirety by reference.

### AREA OF APPLICATION AND PRIOR ART

The invention relates to a heating means for heating water. Such heating devices are also known, in similar form, as instantaneous water heaters and are used for example in water-conducting domestic appliances such as dishwashers, washing machines or the like. The invention also relates to a pump with such a heating means, as known for example from U.S. Ser. No. 10/260,505 B1. The invention likewise relates to a water-conducting domestic appliance with such a heating device, in particular a dishwasher or a washing machine.

A further corresponding water heating means with pump is known from US 2012/224957 A1. This has a tube as heating means or holder for the heating means, to the outer surface of which are affixed heating conductor tracks.

### OBJECT AND ACHIEVEMENT THEREOF

The object of the present invention is a heating means as stated above, a pump with such a heating means, and a water-conducting domestic appliance provided therewith, with which prior art problems can be solved and which in particular makes it possible to heat water rapidly and easily and in particular to configure the entire heating means and pump and the domestic appliance to be operationally reliable and preferably safe from general or local overheating.

This object is achieved by a heating means having the features of claim 1, by a pump having the features of claim 18 and by a water-conducting domestic appliance having the features of claim 22 or 23. Advantageous and preferred embodiments of the invention are the subject matter of further claims and are explained in greater detail below. Some of the features are described here only for the heating means, only for the pump or only for the domestic appliance. They are however intended to be applicable, by themselves and independently of one another, not only to a heating means and a pump provided therewith but also to a domestic appliance comprising these. The wording of the claims is incorporated by express reference into the content of the description.

The heating means for heating water, in particular if the heating means is installed in a pump or is part of a pump, has a tubular, in particular cylindrically configured, holder. This holder is closed circumferentially and in this way defines a heating chamber for the water. In this case, the heating means or the heating chamber thereof may form at least part of the pump chamber or essentially form the chamber of the pump, as is also known per se from the prior art. A pump rotor, in particular an appropriate impeller, for the pump, with which water is conveyed while also being heated, is then arranged within this heating means or heating chamber or this pump chamber. Reference is made to the prior art in this respect too.

A plurality of heating conductors or heating conductor tracks are arranged or deposited on the holder, these being connected together in series and extending over a contiguous region of the outer circumference or of the outer surface of the holder. This contiguous region may have a simple geometric basic shape, for example it may be substantially rectangular. It may however also be provided with protruding regions. Overall, all the heating conductors or heating conductor tracks of the heating means are advantageously provided in the form of one single series interconnection. The heating means is configured for operation in the horizontal state and is arranged in such a way that its longitudinal axis or a longitudinal axis or axis of symmetry of the holder extends substantially horizontally. The pump is configured for this arrangement, in particular also as far as a pump inlet and a pump outlet are concerned. Furthermore, the pump is arranged in such a manner in a domestic appliance according to the invention that the holder of the heating means is arranged or extends with its longitudinal axis substantially horizontal. This is not a problem with the stated domestic appliances, since they are conventionally intended only to be operated in a single, constant position, in particular standing on a horizontal floor or at least oriented horizontally.

According to the invention, in the above-defined horizontal state, i.e., when the longitudinal axis extends horizontally, the heating means has a residual water level that lies between the lowest point and the highest point of the heating chamber. This residual water level is advantageously a horizontal plane or extends horizontally, just as would be expected for a residual water level in the heating means or its heating chamber. The residual water level may also be understood to be a line or two lines on the heating means or the holder thereof which define an area between them. When water is present up to the residual water level in the heating chamber, this area of the holder or heating means is covered by water or water is present at this point. This is important when it comes to heat uptake in the context of the invention, as will be explained below. Provision is made for the heating conductor tracks, apart from one, two or at most four heating conductor tracks, which are in turn connected together in series, to extend below the residual water level, i.e., in the region covered with water. Said one or two heating conductor tracks or at most four heating conductor tracks that do not extend below the residual water level instead extend thereabove or project upward beyond the residual water level. Alternatively, the invention may provide for heating conductor tracks to extend with a proportion of their area amounting to between 3% and 25%, advantageously between 5% and 15%, of the total heating capacity above the residual water level, i.e., to extend in the region that is not always covered with water and to project upward beyond the residual water level.

Unlike the heating conductor tracks extending below the residual water level, the heating conductor tracks extending above said level are not cooled by water on the inner surface when water is present up to the residual water level in the heating chamber. Thus, these heating conductor tracks extending thereabove become hotter in the case of the above-stated water level as they cannot give off as much heat. This situation is exploited according to the invention to ensure that a defined, preferably relatively small, region or area of the heating means or of the heating conductor tracks becomes hotter or markedly hotter than the rest. In this way, overheating may be brought about artificially up to the point of complete failure due to destruction, wherein, due to the slight extent, only these protruding heating conductor tracks are then destroyed and not a larger region with significantly higher total evolution of heat. A safety measure in the form of a kind of defined, narrowly limited self-destruct mechanism can thus be achieved. If just a single heating conductor track extends above the residual water level, this may, as it were, extend in the one direction, preferably straight, as a conductor track. In the opposite direction, i.e., back, it is then guided back with a contact track or incoming-feeder track of material displaying very good, much better electrical conductivity.

In one development of the invention, precisely just one or precisely two heating conductor tracks can be configured such that they extend above the residual water level, and therefore all the other heating conductor tracks extend below the residual water level. They are intended to become hotter than the others in the event of a low water level. If more than two heating conductor tracks were above the residual water level, an undesirably high evolution of heat could arise. In the case of two heating conductor tracks, these are preferably guided in parallel, wherein they may have a relatively small distance between them, of for example 1 mm to 5 mm. At one free end region at maximum height above the residual water level, they may be connected together in series using a conductor bridge, this end region being the region which reaches highest. A connection using a conductor bridge as a substitute for a loop or reversal of direction using heating conductor tracks is known and proven in the prior art as a means of avoiding current crowding. These two heating conductor tracks are preferably connected together in such a way that they are of the same length overall and/or above the residual water level. They may thus extend substantially at right angles to an above-stated line indicating the residual water level on the holder. Alternatively, these two heating conductor tracks may also be of different lengths, specifically overall and/or above the residual water level.

In a further development of the invention, all the heating conductor tracks of the heating means may be connected together in series, wherein they have precisely two electrical terminals. One terminal may be provided at the start and one at the end of the series interconnection of all the heating conductor tracks. This has the major advantage that, in the event of the above-stated failure in the region of the heating conductor tracks protruding above the residual water level due to higher temperatures and the resultant destruction, no more current then flows through one of the heating conductor tracks. This ensures that the stated safety measures work reliably and any further evolution of heat is advantageously stopped.

In a still further development of the invention, said heating conductor tracks that extend higher above the residual water level reach to from 10% to 40% or to 60% of the diameter of the holder higher than the residual water level itself. In particular, they may reach 20% to 50% higher. This is considered sufficient to achieve the desired intense heating of these heating conductor tracks.

In one development of the invention, a tuning region is provided on the holder that is arranged below the residual water level and in which two heating conductor tracks extend next to one another and are connected together in series. They may in particular extend in parallel to one another. They are advantageously in turn connected together at free end regions using a conductor bridge, particularly advantageously in a similar manner to two heating conductor tracks connected together in series. Between these two heating conductor tracks, a shorting jumper for electrical tuning of the electrical resistance of the heating means may be provided upstream of the free end regions or of the conductor bridge, which shorting jumper may be set in place to tune or reduce the electrical resistance of the series interconnection of the two heating conductor tracks. In this way, specifically, the active or effective length thereof may modified, in particular truncated, with the shorting jumper which has been set in place, this depending on the precise point at which the shorting jumper has been set in place. This enables simple electrical tuning of the heating means to a desired resistance value. The shorting jumper should extend at right angles to the heating conductor tracks it connects. Such tuning is fundamentally known from the prior art This tuning region should lie below the residual water level, as the unpredictable effective length of the heating conductor tracks means that no precisely predictable conditions are here available for heat generation.

In a further development of the invention, at least one temperature sensor may be arranged on the holder, wherein this temperature sensor should preferably be arranged above the residual water level. Such a temperature sensor may be configured as a discrete component, for example as an SMD or using THT. It may alternatively be two-dimensional and operate for example by identifying a temperature-dependent leakage current, see in this respect DE 102015218120 A1 or EP 3840528 A1. This arrangement may enable it to detect possible overheating and in general the temperature of the holder may be recorded therewith. Depending on the distance from heating conductor tracks, the temperature measured thereby may be more or less strongly influenced by the individual heating conductor tracks themselves. At a maximum distance from the heating conductor tracks under certain circumstances only the temperature of water flowing through the heating means can be recorded. The sensor may in particular be arranged above the residual water level by about 2% to 20%, preferably 4% to 10%, of the diameter of the holder. A plurality of temperature sensors may also be provided on the holder, for example one temperature sensor close to a protrusion region where heating conductor tracks protrude upward beyond the residual water level. Temperature measurement may thus be performed in the region of the highest expected temperatures.

In one development of the invention, an electrical connection device for the heating means or the heating conductor tracks is provided on the holder, advantageously in the form of a connector plug. The connection device is preferably arranged above the residual water level, primarily because this region has fewer heating conductor tracks than the region below the residual water level. The connection device is particularly preferably arranged above more than half way up the holder, but where possible not maximally high up the holder so as not to increase the vertical structural height of the heating means or the pump in this direction and to ensure maximally flexible installation in a domestic appliance according to the invention. In this case, the connection device may advantageously be arranged on a different side from the heating conductor tracks projecting above residual water level. This allows it to be protected from what may possibly be very high temperatures, specifically when these do not lead to destruction of the heating means but rather the heating means continues to operate after cooling.

In one advantageous development, the tubular holder may be formed by bending together a rectangular metal sheet, which is welded along the two mutually facing edges. The resultant weld seam advantageously lies above the residual water level, preferably in a height range of at least 75% of the height of the heating means or of the holder. Advantageously, the weld seam extends outside the heating conductor tracks and particularly advantageously outside any coating or fittings on the holder; preferably, it is directly the raw material of the holder, in particular metal, which is welded.

In a further development of the invention, all the heating conductor tracks may be of identical width. Their length may vary or at least two groups each with heating conductor tracks of different lengths may be provided. The series interconnection of the heating conductor tracks means that their length makes no difference, electrically speaking. Advantageously, the heating conductor tracks that extend above the residual water level and are provided for overheating in the case of too little water are longer than the other heating conductor tracks. Particularly advantageously, they are identical in length to one another, but this does not have to be the case.

In one development of the invention, all the heating conductor tracks may extend parallel to one another and/or be of linear configuration. It has proven advantageous for in each case two series-connected heating conductor tracks to be connected together at their ends using a conductor bridge. This makes it possible to avoid regions bent into curves or loops at which current crowding and under certain circumstances also damage to the heating conductor tracks may occur.

In one advantageous development of the invention, the holder consists of metal, in particular stainless steel. The heating conductor tracks are advantageously thick-film heating conductor tracks, as known from the prior art for heating means or pumps. Electrical insulation should be provided between the metallic holder and the heating conductor tracks, advantageously in the form of a, for example vitreous or glass-containing, base insulating layer.

The pump preferably takes the form of a radial pump and has an axially extending or directly axial pump inlet that is then coaxial with the longitudinal axis of the holder. Said pump may have a lateral, radial pump outlet that is arranged above the residual water level. Said outlet is preferably arranged above the longitudinal axis of the holder and in particular in the uppermost region of the holder, such that water in fact only exits from the heating means or from the pump chamber to the pump outlet when the pump is operating with the impeller provided therein. In one advantageous development, provision may be made for the pump outlet, when installed, to be arranged at such a vertical height that water automatically exits therefrom until the water level remaining in the pump is at the residual water level. This may likewise also apply in addition or alternatively to the pump inlet.

These and further features are revealed in the description and in the drawings as well as in the claims, wherein the individual features can each be realized singly or severally in the form of sub-combinations in one embodiment of the invention and in other fields, and can represent advantageous and per se protectable embodiments, for which protection is claimed here. The subdivision of the application into individual sections and sub-headings does not limit the statements made thereunder in their general validity.

### BRIEF DESCRIPTION OF THE DRAWINGS

Exemplary embodiments of the invention are shown schematically in the drawings and are explained in more detail below. In the drawings:

FIG. 1 is a schematic functional depiction of a dishwasher according to the invention representing a water-conducting domestic appliance with a pump according to the invention,

FIG. 2 is a sectional representation through a pump according to the invention with a heating means according to the invention that is installed horizontally in the dishwasher of FIG. 1,

FIG. 3 is a developed view of the heating means of the pump of FIG. 2 showing the course of the heating conductor tracks for the heating means and

FIG. 4 shows a modification of a heating means similar to FIG. 3 with heating conductor tracks in mesh configuration.

### DETAILED DESCRIPTION OF THE EXEMPLARY EMBODIMENTS

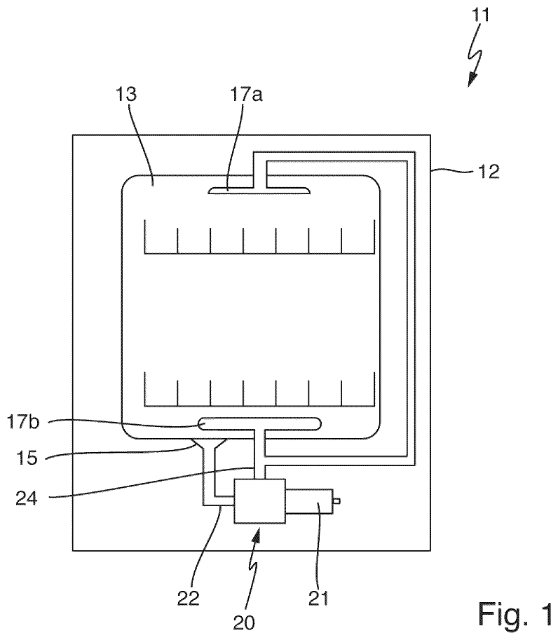

FIG. 1 is a greatly simplified depiction of a dishwasher 11 according to the invention with fundamentally known structure. The dishwasher 11 has a housing 12 and a washing compartment 13 therein. A drain 15 for exiting water extends down from the washing compartment 13. In the washing compartment 13, an upper spray arm 17a is arranged right at the top and a lower spray arm 17b is arranged right at the bottom, these being supplied via water lines. Below the washing compartment 13, a pump 20 according to the invention is arranged, specifically horizontally or with the longitudinal axis of a pump chamber extending horizontally. The pump 20 has a pump motor 21. Coming from the drain 15 on the left is a line connected to a pump inlet 22. The pump 20 takes the form of a radial pump and has a radially exiting pump outlet 24 to the side of the pump chamber. The pump outlet 24 extends via lines to the upper spray arm 17a and the lower spray arm 17b. As is known from the prior art, water is heated by the pump 20 during pumping, as specifically the pump chamber thereof is heated.

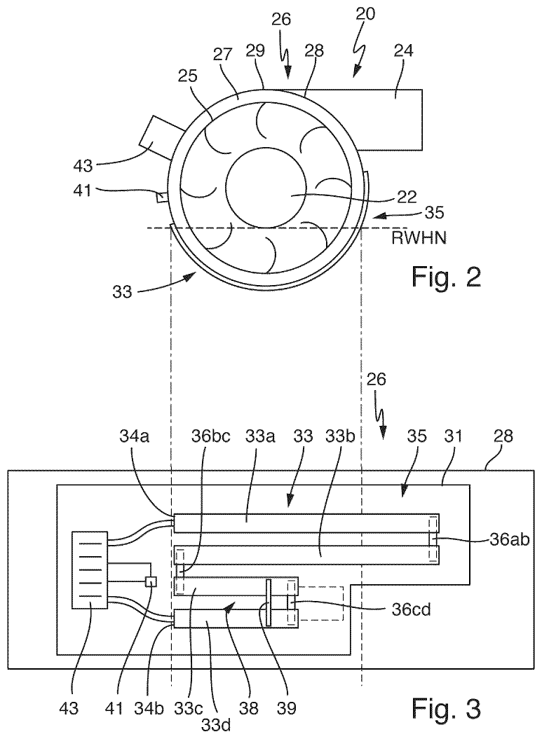

FIG. 2 shows a section through a pump 20 according to the invention, which is arranged horizontally when in operation or the longitudinal axis of which extends horizontally. The pump 20 has an impeller 25, which is driven by the above-stated pump motor 21. The impeller 25 runs inside the heating means 26, which forms or has a heating compartment 27 corresponding to a pump chamber. A tubular holder 28, in particular of circular configuration, is provided for the heating means 26. A developed view of the holder 28 is shown in FIG. 3 therebelow. It is readily apparent that the holder 28 consists of a rectangular part, in particular of a stainless steel sheet, and is bent at the left- and right-hand narrow sides of FIG. 3 to form the tube of FIG. 2. These narrow sides are joined tightly together by means of a weld seam 29, see top of FIG. 2.

It is clear from FIG. 3 that a base insulation 31, for example containing glass, is deposited on the outer surface of the holder 28, as the metallic holder 28 itself is electrically conductive. Four heating conductor tracks 33 are deposited on the base insulation 31, but more are also possible. All the heating conductor tracks 33 are configured parallel to one another and at the same time parallel to the longitudinal edges of the developed view of the holder 28. They extend fully on the base insulation 31. In precisely the same way as this base insulation 31, the heating conductor tracks 33 may also be deposited thereon using a thick-film method, in particular by screen printing.

The upper two heating conductor tracks 33a and 33b are considerably longer than the lower two heating conductor tracks 33c and 33d, here roughly twice as long. They are here of the same length, which is not essential, however, as they could also be of different lengths, both below and/above the residual water level RWHN. As is apparent from FIG. 2, when actually installed they are arranged with their left-hand ends, at which the uppermost heating conductor track 33a has a first terminal 34a, roughly at the point where a residual water level RWHN extends due to the central pump inlet 22. In FIG. 3, RWHN is shown in dashed lines close to the left-hand ends of the heating conductor tracks 33. To the right thereof, RWHN is likewise shown in dashed lines at the point where it once again intersects according to FIG. 2 with the holder 28. It is thus readily apparent that the heating conductor tracks 33a and 33b extend markedly beyond RWHN in a protrusion region 35, see also FIG. 2, right-hand side above RWHN. In this protrusion region 35, the two heating conductor tracks 33a and 33b may protrude by around 25% above RWHN, but this may advantageously be up to 60%, preferably around 40% to 50%. As stated above, it could also be just one single heating conductor track 33, for example the upper heating conductor track 33a. The lower heating conductor track 33b could then be embodied as an extension of the conductor bridge 36ab as far as the other conductor bridge 36bc and consist of material with a considerably higher electrical conductivity. It is apparent from FIG. 2 that when the pump chamber, corresponding to the heating compartment 27, is filled completely or to more than 60%, water is present opposite all the heating conductor tracks 33 on the inner surface of the holder 28, i.e., sufficiently good heat uptake from the heating conductor tracks 33 is guaranteed. In particular, on operation of the pump with an impeller 25, water is located substantially over the entire inner surface of the holder 28. If, however, the water level falls below the maximum height of the protrusion region 35 with the two heating conductor tracks 33a and 33b, uptake of the heat therefrom is no longer as good or becomes ever worse. Due to the arrangement of the pump inlet 22, RWHN is at most this high; under certain circumstances even less residual water may be present in the pump chamber or in the heating compartment 27. As the water level falls or if the water level is at RWHN, the heating conductor tracks 33a and 33b overheat in the protrusion region 35. This may also be further increased by the fact that they consist of a PTC material, and therefore their electrical resistance increases as temperature rises. If the two heating conductor tracks 33a and 33b in the protrusion region 35, which is not cooled by water, heat up, the temperature rises, as does the electrical resistance. However, this is the case only within the protrusion region 35, such that due to the small fraction of the whole, the total resistance increases only slightly. Therefore, a high current continues to flow through the heating means 26 or through the heating conductor tracks 33 thereof, which then leads to an increasing and thus under certain circumstances very high temperature in the uncooled protrusion region 35. In this case, in the fault scenario of too little water, one of the heating conductor tracks 33a or 33b in the protrusion region 35 can or even is intended to burn through or be destroyed. Current flow through the entire heating means 26 then stops immediately. The heating means 26 is then destroyed and has to be replaced. More significant damage to the entire pump 20 or even to the dishwasher 11 can, however, be avoided thereby.

It is therefore also recommended, even if the heating means 26 has more than four heating conductor tracks 33, that actually just one heating conductor track, exactly two heating conductor tracks or a maximum of four heating conductor tracks 33 protrude beyond RWHN in the protrusion region 35.

Such an above-stated fault scenario, which is intended to be handled thereby so to speak, may arise if the water supply either stops, is clogged or is not functional. It may alternatively arise if, despite the heating means 26 being operated or energized, the pump motor 21 cannot convey any water.

The two lower heating conductor tracks 33c and 33d could also still, as shown with dashed lines, extend further to the right-hand dashed line for RWHN. The lowermost heating conductor track 33b has the second electrical terminal 34b. Conductor tracks (not shown) connect the electrical terminals 34a and 34b to the electrical connector plug 43. As is apparent from FIGS. 2 and 3, the electrical connector plug 43 is arranged below or outside the weld seam 29 and in particular can be arranged, as it were uncooled, at a location above RWHN. At the same time, however, the heating conductor tracks 33 are at a significant distance therefrom.

A discrete temperature sensor 41 is arranged between the electrical connector plug 43 and the heating conductor tracks 33. It may be, for example, an SMD component. The temperature sensor 41 is also connected by way of conductor tracks (not shown) to the electrical connector plug 43, as is known from the prior art.

Further heating conductor tracks in parallel form could also be provided, for example above the upper heating conductor track 33a. These should then, however, be just as short as the lower heating conductor tracks 33c and 33d or shorter than the heating conductor tracks 33a and 33b, in particular they should not project into the protrusion region 35.

The two lower heating conductor tracks 33c and 33d have an above-stated tuning region 38. Precisely one shorting jumper 39, for example made from a similar material to the conductor bridges 36, or alternatively from a more easily depositable material, is deposited therebetween for this purpose. In this case, the shorting jumper 39 is set in place at a precisely determined location. The electrical resistance here between these two heating conductor tracks 33c and 33d and also for the series interconnection of all the heating conductor tracks 33, accordingly becomes smaller, since a specific length of these two heating conductor tracks, namely to the right beside the shorting jumper 39, is as it were electrically cut off. An electrical resistance value for the heating means 26 can thus be precisely set in known manner. Such a tuning region 38 should of course always be below RWHN and thus where it is most likely to be cooled by water below RWHN.

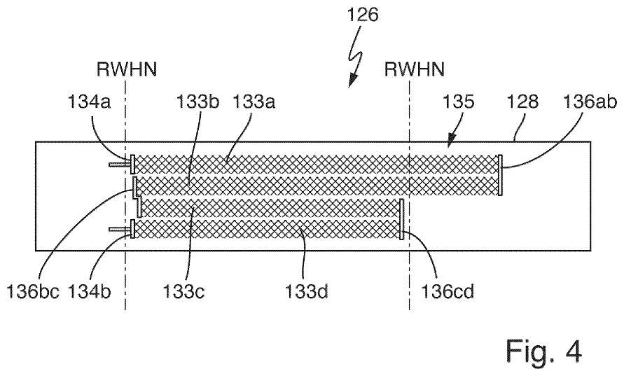

FIG. 4 shows a heating means 126 with a rectangular holder 128 which is a developed view of a tubular heating means for a pump similar to FIG. 2. The heating means 126 has four heating conductor tracks 133a to 133d. These heating conductor tracks are all of identical width or identically constructed, specifically in mesh form or mesh- or grid-like manner according to WO 2021/170331 A1. They have a width of around three or four grid-like meshes. This is also generally an advantageous option for the development of the heating conductor tracks 133 in addition to those of FIG. 3, which are full-surface or continuous.

On the left, they begin in each case at the RWHN shown with dash-dotted lines corresponding to FIGS. 2 and 3. The upper two heating conductor tracks 133a and 133b project to the right beyond the right-hand dash-dotted RWHN line with a protrusion region 135, where they are connected by a conductor bridge 136ab. Otherwise, a further conductor bridge 136bc is additionally provided between the heating conductors 133b and 133c and a conductor bridge 136cd between the heating conductors 133c and 133d. The terminals 134a and 134b provide an electrical connection to the heating conductor tracks 133.

On the basis of the depiction in FIG. 4 in comparison with FIG. 3, it is also easy to conceive how various developments of the heating conductor tracks might be combined. Mesh form or mesh- or grid-like heating conductor tracks corresponding to FIG. 4 can accordingly be combined, specifically in any desired way, with heating conductor tracks with a full-surface or continuous configuration corresponding to FIG. 3. For example, in a development similar to FIG. 3, the uppermost heating conductor track 33a and the lower two heating conductor tracks 33c and 33d could be of full-surface or continuous configuration, while the second uppermost heating conductor track 33b could in contrast be in mesh form or of mesh- or grid-like configuration corresponding to FIG. 4. Each heating conductor track is advantageously in itself, i.e., between the ends thereof or between the terminals 34 or conductor bridges 36, of identical construction such that there is here no change between mesh form and continuous.

1. A heating means for heating water, said heating means having:
a tubular holder being closed circumferentially and defining a heating chamber for said water,
a plurality of heating conductor tracks on said tubular holder, said heating conductor tracks being connected together in series and extending over a contiguous region of an outer circumference of said holder,
said heating means being configured for operation in a horizontal state and being arranged in such a way that a longitudinal axis or a longitudinal axis of said holder extends substantially horizontally,
wherein,
in said horizontal state, said heating means has a residual water level lying between a lowest point and a highest point of said heating chamber,
apart from precisely one, two or at most four of said heating conductor tracks being connected together in series, said heating conductor tracks extend below said residual water level, and
said precisely one, two or at most four heating conductor tracks extend above said residual water level.

2. The heating means as claimed in claim 1, wherein precisely two said heating conductor tracks extend above said residual water level, said heating conductor tracks being guided in parallel, and connected together in series using a conductor bridge at a free end region at maximum height above said residual water level.

3. The heating means as claimed in claim 2, wherein said precisely two heating conductor tracks are connected together in such a way to have the same length above said residual water level.

4. The heating means as claimed in claim 1, wherein all said heating conductor tracks are connected together in series and have precisely two electrical terminals, one said electrical terminal at a start and one said electrical terminal at an end of a series interconnection of all said heating conductor tracks.

5. The heating means as claimed in claim 1, wherein said heating conductor tracks reach above said residual water level to from 10% to 60% higher than said residual water level.

6. The heating means as claimed in claim 1, wherein a tuning region is provided being arranged below said residual water level, wherein said heating conductor tracks extend in said tuning region next to one another and are connected together in series, there being provided between said two heating conductor tracks a shorting jumper for electrical tuning of said heating means, wherein said shorting jumper can be manufactured subsequently to reduce an electrical resistance of said series interconnection of said two heating conductor tracks.

7. The heating means as claimed in claim 1, wherein at least one temperature sensor is a discrete component and is arranged on said holder above said residual water level.

8. The heating means as claimed in claim 7, wherein said temperature sensor is arranged on said holder above said residual water level by 2% to 20% of a diameter of said holder.

9. The heating means as claimed in claim 1, wherein an electrical connection device is provided on said holder above said residual water level.

10. The heating means as claimed in claim 9, wherein said electrical connection device is arranged on a different side from said heating conductor tracks projecting above said residual water level.

11. The heating means as claimed in claim 1, wherein said holder is formed from a rectangular metal sheet by bending together and welding with a weld seam along edges mutually facing each other, said weld seam extending above said residual water level and outside said heating conductor tracks.

12. The heating means as claimed in claim 11, wherein said weld seam extends in a height range of at least 75% of a height of said heating means.

13. The heating means as claimed in claim 1, wherein all said heating conductor tracks are of identical width.

14. The heating means as claimed in claim 1, wherein said heating conductor tracks extending above said residual water level are longer than said other heating conductor tracks.

15. The heating means as claimed in claim 1, wherein all said heating conductor tracks extend parallel to one another or are of linear configuration.

16. The heating means as claimed in claim 1, wherein said heating conductor tracks are thick-film heating conductor tracks.

17. The heating means as claimed in claim 1, wherein said holder consists of metal.

18. A pump with said heating means as claimed in claim 1, wherein
said heating means or said heating chamber of said heating means form at least part of said pump chamber or essentially forms said pump chamber,
a pump rotor is arranged within said heating means or within said heating chamber.

19. The pump as claimed in claim 18, wherein said pump takes a form of a radial pump with an axial pump inlet being coaxial with said longitudinal axis of said holder of said heating means, and with a lateral pump outlet, said lateral pump outlet being arranged above said residual water level.

20. The pump as claimed in claim 19, wherein said pump outlet is arranged above a longitudinal axis of said holder and at a height of an uppermost region of said holder.

21. The pump as claimed in claim 19, wherein said pump outlet is arranged at a height such that water automatically exits therefrom until said water level remaining in said pump or in said pump chamber is at said residual water level.

22. A water-conducting domestic appliance with a heating means as claimed in claim 1, wherein said holder of said heating means has a longitudinal axis and is arranged in said domestic appliance with said longitudinal axis being substantially horizontal.

23. A water-conducting domestic appliance with a pump as claimed in claim 18, wherein said holder of said heating means has a longitudinal axis and is arranged in said domestic appliance with said longitudinal axis being substantially horizontal.
